(19) United States
(12) Patent Application Publication
(10) Pub. No.: US 2026/0267461 A1
(43) Pub. Date: Sep. 10, 2026

(54) DESKTOP ICON SORTING METHOD AND APPARATUS, MEDIUM, AND DEVICE

(71) Applicant: SHENZHEN TCL NEW TECHNOLOGY CO., LTD., Shenzhen, Guangdong (CN)

(72) Inventor: Sixin DENG, Shenzhen, Guangdong (CN)

(73) Assignee: SHENZHEN TCL NEW TECHNOLOGY CO., LTD., Shenzhen, Guangdong (CN)

(21) Appl. No.: 19/491,371

(22) PCT Filed: Apr. 12, 2024
(86) PCT No.: PCT/CN2024/087549

§ 371 Date: Dec. 8, 2025

(30) Foreign Application Priority Data
Jul. 4, 2023 (CN) 202310814681.4

(51) Int. Cl. G06F 3/04817; G06F 3/0486; G06F 3/04883

(52) U.S. Cl. CPC G06F 3/04817; G06F 3/0486; G06F 3/04883

(57) ABSTRACT

The present application provides a desktop icon sorting method and apparatus, a medium, and a device. The method comprises: recording first position coordinates of a first target icon, and recording second position coordinates of a second target icon when a second touch operation is completed; creating a moving path between the first target icon and the second target icon on the basis of the first position coordinates and the second position coordinates; and merging the second target icon with the first target icon. The icon merging method of the present application is more convenient and is less prone to error.

This application claims priority to Chinese Application No. 202310814681.4 filed Jul. 4, 2023, and entitle with “DESKTOP ICON SORTING METHOD AND APPARATUS, MEDIUM, AND DEVICE”, the contents of which are incorporated herein by reference in their entirety.

### FIELD OF THE INVENTION

The present disclosure relates to a desktop icon arrangement method, an apparatus, a computer-readable storage medium, and an electronic device.

### BACKGROUND

When merging application icons, it is usually achieved by long-pressing an application icon to make a current operation interface enter an editable state, and then moving the long-pressed application icon to a designated position to automatically aggregate it with another application icon into a folder, or to move it onto another folder to automatically merge it into the folder. However, this manner requires a user to press and hold the icon with a finger and move it on the operation interface while keeping the finger in continuous contact with the icon without leaving the operation interface. Such an operation is cumbersome, and when the finger is accidentally lifted or the moved target range deviates, a failure of icon merging may occur.

### SUMMARY

An embodiment of the present disclosure provides a desktop icon arrangement method, an apparatus, a medium, and a device. By using the desktop icon arrangement method provided in the embodiment of the present disclosure, it is possible to avoid a situation in which the icon merging fails when the finger is accidentally lifted or when the target range of movement deviates.

An embodiment of the present disclosure provides a desktop icon arrangement method, the desktop icon arrangement method comprising:
responding to a first touch operation on a first target icon on an operation interface, and recording a first position coordinate of the first target icon on the operation interface;
responding to a second touch operation on any second target icon on the operation interface other than the first target icon, and recording a second position coordinate of the second target icon when the second touch operation on the operation interface is completed;
creating a movement path between the first target icon and the second target icon according to the first position coordinate and the second position coordinate; and based on the movement path, moving the second target icon to a position of the first target icon for merging.

In the desktop icon arrangement method according to the embodiment of the present disclosure, the second touch operation specifically refers to a clicking operation on the second target icon.

In the desktop icon arrangement method according to the embodiment of the present disclosure, the second touch operation specifically comprises:
performing a first long-press operation on the second target icon to grant the second target icon a dragging permission; and dragging the second target icon having the dragging permission in a designated direction.

In the desktop icon arrangement method according to the embodiment of the present disclosure, the method further comprises:
determining a first straight line formed by the designated direction, and a second straight line formed by connecting the first target icon and the second target icon in an initial state;
determining whether an included angle formed between the first straight line and the second straight line exceeds a preset threshold; and when the included angle exceeds the preset threshold, resetting the second target icon.

In the desktop icon arrangement method according to the embodiment of the present disclosure, the method further comprises:
when the included angle exceeds the preset threshold, releasing the second target icon after completing the dragging operation so that the second target icon moves along the designated direction;
obtaining an incidence angle between the second target icon and a boundary when the second target icon collides with the boundary on the operation interface; and controlling the second target icon to perform at least one boundary rebound action according to the incidence angle, and then moving to the position of the first target icon for merging.

In the desktop icon arrangement method according to the embodiment of the present disclosure, based on a movement path, moving a second target icon to a position of a first target icon for merging comprises:
calculating a distance value between a first position coordinate and a second position coordinate; and based on the movement path, moving the second target icon to a position at the distance value from itself to merge with the first target icon.

In the desktop icon arrangement method according to the embodiment of the present disclosure, based on the movement path, moving the second target icon to the position of the first target icon for merging comprises:
calculating a dragging speed of the second target icon during a dragging operation; and
based on the movement path, moving the second target icon at the dragging speed to a position at the distance value from itself to merge with the first target icon.

In the desktop icon arrangement method according to the embodiment of the present disclosure, the method further comprises:
detecting whether the dragging speed falls within a preset value range, and when the dragging speed does not fall within the preset value range, replacing the dragging speed with a maximum preset speed or a minimum preset speed that is closest to the dragging speed.

In the desktop icon arrangement method according to the embodiment of the present disclosure, before responding to a first touch operation on a first target icon on an operation interface, the method further comprises:
responding to a second long-press operation on any icon on the operation interface, and popping up a confirmation control used to indicate whether to convert a current icon from an initial state into a receiving state; and
when detecting that the confirmation control is triggered, setting the current icon as the first target icon.

In the desktop icon arrangement method according to the embodiment of the present disclosure, after responding to the first touch operation on the first target icon on the operation interface, the method further comprises:
placing the first target icon at a topmost layer of the operation interface; and
responding to a page switching operation on the operation interface to switch a current page to another page while the first target icon remains unmoved.

Accordingly, another aspect of the embodiment of the present disclosure further provides a desktop icon arrangement apparatus, the desktop icon arrangement apparatus comprising:
a first response module, configured to respond to the first touch operation on the first target icon on the operation interface and record a first position coordinate of the first target icon on the operation interface;
a second response module, configured to respond to a second touch operation on any second target icon on the operation interface other than the first target icon, and record a second position coordinate of the second target icon when the second touch operation on the operation interface is completed;
a path creation module, configured to create a movement path between the first target icon and the second target icon according to the first position coordinate and the second position coordinate; and
an icon merging module, configured to move the second target icon to a position of the first target icon based on the movement path for merging.

Accordingly, another aspect of the embodiment of the present disclosure further provides a storage medium, where the storage medium stores multiple instructions, and the instructions are adapted to be loaded by a processor to execute the desktop icon arrangement method as described above.

Accordingly, another aspect of the embodiment of the present disclosure further provides a terminal device, comprising a processor and a memory. The memory stores multiple instructions, and the processor loads the instructions to execute the desktop icon arrangement method as described above.

The embodiment of the present disclosure provides a desktop icon arrangement method, an apparatus, a storage medium, and a device. The method includes: responding to a first touch operation on a first target icon on an operation interface, and recording a first position coordinate of the first target icon on the operation interface; responding to a second touch operation on any second target icon on the operation interface other than the first target icon, and recording a second position coordinate of the second target icon when the second touch operation on the operation interface is completed; creating a movement path between the first target icon and the second target icon according to the first position coordinate and the second position coordinate; and based on the movement path, moving the second target icon to a position of the first target icon for merging.

By adopting the desktop icon arrangement method provided by the embodiment of the present disclosure, the first target icon to be merged and the second target icon that actively merges are sequentially determined. Only a touch operation needs to be performed on the second target icon to automatically merge the second target icon with the first target icon. Compared with the existing icon merging manner, it does not require a user to press and hold an icon with a finger and move it on the operation interface while keeping the finger in continuous contact with the icon without leaving the operation interface. The operation is not only more convenient but also can avoid a situation in which an icon merging failure occurs when the finger is accidentally lifted or when the moved target range deviates.

### BRIEF DESCRIPTION OF THE DRAWINGS

In order to more clearly illustrate the technical solutions in the embodiments of the present disclosure, the drawings to be used in the description of the embodiments are briefly introduced below. It is obvious that the drawings in the following description merely show some embodiments of the present disclosure. For those skilled in the art, other drawings can also be obtained based on these drawings without any inventive effort.

FIG. 1 is a schematic diagram illustrating an application scenario of a desktop icon arrangement method according to an embodiment of the present disclosure.

FIG. 2 is a flowchart of a desktop icon arrangement method according to an embodiment of the present disclosure.

FIG. 3 is a schematic structural diagram illustrating a desktop icon arrangement apparatus according to an embodiment of the present disclosure.

FIG. 4 is another schematic structural diagram illustrating a desktop icon arrangement apparatus according to an embodiment of the present disclosure.

FIG. 5 is a schematic structural diagram illustrating a terminal device according to an embodiment of the present disclosure.

### DETAILED DESCRIPTION OF THE PRESENT DISCLOSURE

The technical solutions in the embodiments of the present disclosure are clearly and completely described with reference to the accompanying drawings of the embodiments of the present disclosure. It is obvious that the described embodiments are merely a part of the embodiments of the present disclosure, rather than all of the embodiments. Based on the embodiments in the present disclosure, all other embodiments obtained by those skilled in the art without creative effort shall fall within the protection scope of the present disclosure.

An embodiment of the present disclosure provides a desktop icon arrangement method. By sequentially determining a first target icon to be merged and a second target icon to actively merge, only a touch operation needs to be performed on the second target icon to automatically merge the second target icon with the first target icon. Compared with existing icon merging methods, it does not require a user to press and hold an icon with a finger and move it on an operation interface while keeping the finger in continuous contact with the icon without leaving the operation interface. The operation is not only convenient but also can avoid a situation in which an icon merging failure occurs when the finger is accidentally lifted or when the moved target range deviates. The details are described below.

In the present disclosure, the term “and/or” is used to describe a relationship between associated objects, indicating that three types of relationships may exist. For example, A and/or B may indicate three cases: A alone, both A and B together, and B alone. In addition, the character “/” in the present disclosure generally indicates that the associated objects before and after it are in an “or” relationship.

In the description, claims, and drawings of the present disclosure, the terms “first,” “second,” and the like are used to distinguish similar objects and are not intended to indicate a specific order or sequence. It should be understood that such data can be interchanged when appropriate, so that the embodiments described herein can be implemented in an order other than that illustrated or described.

In addition, the terms “comprise” and “have,” and any variations thereof, are intended to cover non-exclusive inclusion. For example, a process, method, system, product, or device that comprises a series of steps or modules is not necessarily limited to the clearly listed steps or modules, but may further include other steps or modules that are not clearly listed or are inherent to the process, method, product, or device.

The naming or numbering of steps appearing in the present disclosure does not imply that the steps of a method flow must be performed in the temporal or logical order indicated by the names or numbers. The flow steps that have been named or numbered can be executed in an altered sequence according to the technical objective to be achieved, as long as the same or similar technical effects can be obtained.

The division of modules appearing in the present disclosure is a logical division. In actual implementation, other division manners may be adopted; for example, multiple modules may be combined into or integrated within another system, some features may be omitted or not executed, and the coupling, direct coupling, or communication connection between the displayed or discussed modules may be through certain interfaces. Indirect coupling or communication connection between modules may be electrical or other similar forms, which are not limited in the present disclosure. Furthermore, modules or submodules described as separate components may or may not be physically separated, may or may not be physical modules, or may be distributed among multiple circuit modules. Some or all of the modules can be selected as needed to achieve the objectives of the solution of the present disclosure.

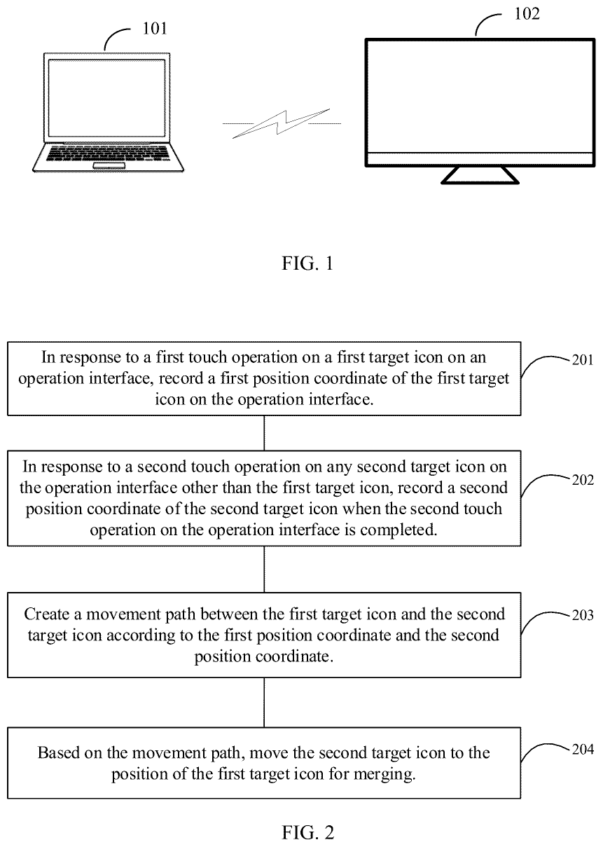

An application scenario of the embodiment of the present disclosure is shown in FIG. 1, which includes a sending end 101 and a receiving end 102. The receiving end 102 and the sending end 101 can communicate with each other through a network connection.

For ease of understanding, the specific process in the embodiment of the present disclosure is described below. Please refer to FIG. 2.

FIG. 2 is a schematic flow diagram illustrating one embodiment of a desktop icon arrangement method provided in the embodiment of the present disclosure.

In the embodiment shown in FIG. 2, the method may include the following steps:

Step 201: Responding to a first touch operation on a first target icon on an operation interface, and recording the first position coordinate of the first target icon on the operation interface.

It should be noted that the icon arrangement described in this solution mainly refers to merging multiple related icons into a folder, or merging multiple arbitrary icons into a folder based on user preference. In the present embodiment, a passively merged icon or folder is taken as the first target icon. When a user wishes to perform an icon arrangement operation on a terminal device running the desktop icon arrangement method, it is necessary first to determine a target icon or a target folder to be passively merged and take it as the first target icon. The first touch operation is then performed on the first target icon so that the first target icon has an active function of receiving other icons to be merged, while recording the first position coordinate of the first target icon on the operation interface for subsequent icon merging.

In one example, the first touch operation can be triggered by long-pressing the first target icon. Specifically, long-pressing the first target icon refers to continuously pressing the first target icon for a duration exceeding a first preset value. In actual operation, after the user long-presses the first target icon, the first target icon can also be automatically enlarged to distinguish it from other icons that are not operated. In some optional examples, the first touch operation can also be triggered by continuously clicking the first target icon N times, where N is an integer greater than 1. In some optional examples, the first touch operation can also be triggered by performing a circling operation or a check-mark operation on the first target icon. The present disclosure imposes no limitation on the manner of triggering the first touch operation, and it can be specifically set based on user habits.

When the processing logic of the above operation is described from the perspective of the terminal device, the terminal device first determines a first straight line formed based on the designated direction, and a second straight line formed by connecting the first target icon and the second target icon in the initial state. It is then determined whether the included angle formed between the first straight line and the second straight line exceeds a preset threshold. When the included angle exceeds the preset threshold, the terminal device determines that the second touch operation is invalid and resets the second target icon.

In some embodiments, the movement path between the first target icon and the second target icon may be set not only as a straight-line animation path, but also as a curved movement path, which can be specifically adjusted based on user preference and the type of device. For example, the execution of the movement path may be adjusted using a Bézier curve algorithm to increase the visual and interactive appeal of the movement.

In some embodiments, in order to further enhance user experience during icon arrangement, the present solution optimizes the second touch operation so that the user can align the second target icon with the boundary of the operation interface and release it. After release, the second target icon collides with the designated boundary and performs at least one boundary rebound action based on the incidence angle, and then moves to the position of the first target icon for merging, turning the desktop icon arrangement process into an engaging collision game.

Step 202: Responding to a second touch operation on any second target icon on the operation interface other than the first target icon, and recording the second position coordinate of the second target icon when the second touch operation on the operation interface is completed.

After determining the first target icon and completing the first touch operation on the first target icon, the user needs to select a target icon to be merged from any icon on the operation interface other than the first target icon. To distinguish it from the first target icon, the selected icon is taken as the second target icon. By performing the second touch operation on the second target icon, a precondition for automatically merging the second target icon with the first target icon is triggered, while recording the second position coordinate of the second target icon when the second touch operation on the operation interface is completed, which is used for subsequent icon merging.

In one example, the second touch operation specifically refers to a clicking operation on the second target icon. The number of clicks is M times; that is, it only requires clicking the second target icon. To prevent accidental touches, the number of clicks M may be set to at least two.

In another optional example, the second touch operation specifically comprises: performing a first long-press operation on the second target icon so that the second target icon is granted dragging permission. Specifically, the first long-press operation refers to continuously pressing the second target icon for a duration exceeding a second preset value. By performing the first long-press operation on the second target icon, the user can long-press the second target icon and drag it in any direction and distance; and dragging the second target icon having the dragging permission in the designated direction.

It should be noted that the user only needs to determine the dragging direction and drag the second target icon for a certain distance to trigger the second touch operation. It is unnecessary, as in traditional icon arrangement methods, to drag the second target icon until it makes physical contact with the first target icon. Comparatively, the desktop icon arrangement method provided in the present disclosure is more convenient and less prone to error.

Step 203: Creating a movement path between the first target icon and the second target icon according to the first position coordinate and the second position coordinate.

It should be explained that the purpose of creating the movement path between the first target icon and the second target icon is to automatically control the merging of the second target icon with the first target icon, thereby replacing manual dragging.

Step 204: Based on the movement path, moving the second target icon to the position of the first target icon for merging.

To enable the second target icon to automatically and accurately approach the first target icon, in the present embodiment, a distance value between the first position coordinate and the second position coordinate is calculated. Based on the movement path, the second target icon is moved to a position at the distance value from itself to merge with the first target icon.

In another embodiment, a dragging speed of the second target icon during a dragging operation can also be calculated. Based on the movement path, the second target icon is moved at the dragging speed to a position at the distance value from itself to merge with the first target icon, so that the user can perceive that adopting different dragging speeds changes the movement speed at which the second target icon merges with the first target icon.

It should be noted that, based on the initial position coordinate of the second target icon and the second position coordinate when the second touch operation is completed, the distance that the user drags the second target icon can be obtained. Since the dragging duration of the second target icon can be automatically acquired, the dragging speed of the second target icon during the dragging operation can be directly calculated.

In summary, when merging application icons, it is usually achieved by long-pressing an application icon to make the current operation interface enter an editable state, and then moving the long-pressed application icon to a designated position to automatically aggregate it with another application icon into a folder, or moving it onto another folder to automatically merge it into the folder. However, this manner requires the user to press and hold the icon with a finger and move it on the operation interface while keeping the finger in continuous contact with the icon without leaving the operation interface. Such an operation is cumbersome, and when the finger is accidentally lifted or the moved target range deviates, a failure of icon merging may occur.

To solve this problem, the present solution sequentially determines the first target icon to be merged and the second target icon to actively merge. Only a touch operation needs to be performed on the second target icon to automatically merge the second target icon with the first target icon. Compared with existing icon merging methods, the desktop icon arrangement method provided by the present disclosure is more convenient and less prone to error.

In some embodiments, by using the desktop icon arrangement method provided by the present disclosure, the user only needs to determine the dragging direction and drag the second target icon for a certain distance to trigger the second touch operation. However, in actual operation, the user may temporarily wish to cancel the operation during the dragging of the second target icon. Therefore, a temporary cancellation function is introduced. Specifically, the second target icon can be configured to trigger the second touch operation only when aligned with the position of the first target icon, while allowing a certain deviation range. When the terminal device detects that the second target icon deviates beyond a preset deviation range, it determines that the second touch operation is invalid. Based on this design, when the user wishes to temporarily cancel during the dragging of the second target icon, the user only needs to drag the second target icon in a direction away from the first target icon.

When the processing logic of the above operation is described from the perspective of the terminal device, the terminal device first determines a first straight line formed based on the designated direction and a second straight line formed by connecting the first target icon and the second target icon in the initial state. The terminal device then determines whether the included angle formed between the first straight line and the second straight line exceeds a preset threshold. When the included angle exceeds the preset threshold, the terminal device determines that the second touch operation is invalid and resets the second target icon.

In some embodiments, the movement path between the first target icon and the second target icon can be set not only as a straight-line animation path but also as a curved movement route. The specific path can be adjusted based on user preference and the device type, for example, by using a Bézier curve algorithm to adjust the execution of the movement path, thereby increasing the entertainment effect of the movement.

In some embodiments, in order to further enhance user experience during the icon arrangement process, the present solution optimizes the second touch operation, enabling the user to align the second target icon with the boundary of the operation interface and release it. After release, the second target icon collides with the designated boundary and performs at least one boundary rebound action based on the incidence angle, and then moves to the position of the first target icon for merging, thereby turning desktop icon arrangement into an interesting collision game.

When the processing logic of the above operation is described from the perspective of the terminal device, the terminal device first detects whether the included angle formed between the first straight line and the second straight line exceeds a preset threshold. When the included angle exceeds the preset threshold, the terminal device controls the second target icon, after completing the dragging operation, to move along the designated direction, and acquires an incidence angle between the second target icon and a boundary when the second target icon collides with the boundary on the operation interface. The terminal device then controls the second target icon to perform at least one boundary rebound action based on the incidence angle, and subsequently move to the position of the first target icon for merging.

It should be noted that, in order to avoid a conflict between the embodiment designed to enhance the entertainment of the second touch operation and the embodiment designed for temporarily canceling the second touch operation, it can be stipulated that, before performing the embodiment for enhancing the entertainment of the second touch operation, the second target icon needs to be dragged in the direction opposite to its launching direction, similar to the charging action of an arrow before being released.

All of the above optional technical solutions can be combined in any manner to form optional embodiments of the present disclosure, and will not be redundantly described here.

In specific implementations, the present disclosure is not limited by the execution sequence of the steps described. As long as no conflict occurs, certain steps may also be performed in other sequences or simultaneously.

As described above, the desktop icon arrangement method provided by the embodiments of the present disclosure includes: responding to a first touch operation on a first target icon on an operation interface, and recording a first position coordinate of the first target icon on the operation interface; responding to a second touch operation on any second target icon on the operation interface other than the first target icon, and recording a second position coordinate of the second target icon when the second touch operation on the operation interface is completed; creating a movement path between the first target icon and the second target icon according to the first position coordinate and the second position coordinate; and, based on the movement path, moving the second target icon to a position of the first target icon for merging.

By using the desktop icon arrangement method provided by the embodiments of the present disclosure, through sequentially determining a first target icon to be merged and a second target icon to actively merge, it is only necessary to perform a touch operation on the second target icon to automatically merge the second target icon with the first target icon. Compared with existing icon merging methods, this approach eliminates the need for the user to press and hold an icon with a finger and move it on the operation interface while keeping the finger continuously in contact with the icon without leaving the operation interface. This not only simplifies the operation but also avoids a failure of icon merging that may occur when the finger is accidentally lifted or when the moved target range deviates. Detailed descriptions are provided below.

The embodiments of the present disclosure further provide a desktop icon arrangement apparatus, which can be integrated into a terminal device.

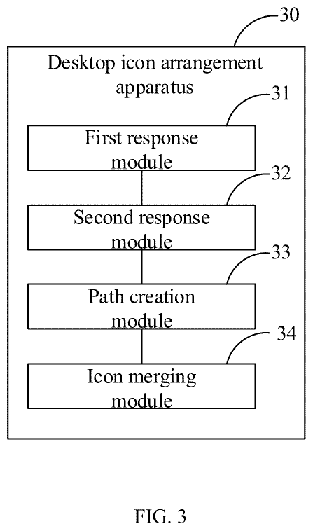

Referring to FIG. 3 illustrating a block diagram of the desktop icon arrangement apparatus according to an embodiment of the present disclosure.

The desktop icon arrangement apparatus 30 includes a first response module 31, a second response module 32, a path creation module 33, and an icon merging module 34.

The first response module 31 is configured to respond to a first touch operation on a first target icon on an operation interface, and record a first position coordinate of the first target icon on the operation interface.

The second response module 32 is configured to respond to a second touch operation on any second target icon on the operation interface other than the first target icon, and record a second position coordinate of the second target icon when the second touch operation on the operation interface is completed.

The path creation module 33 is configured to create a movement path between the first target icon and the second target icon according to the first position coordinate and the second position coordinate.

The icon merging module 34 is configured to, based on the movement path, move the second target icon to a position of the first target icon for merging.

In some embodiments, the second touch operation specifically refers to a clicking operation on the second target icon.

In some embodiments, the second touch operation specifically includes performing a first long-press operation on the second target icon so that the second target icon is granted dragging permission, and dragging the second target icon having the dragging permission in a designated direction.

In some embodiments, the apparatus further includes a first determination module, configured to determine a first straight line formed according to the designated direction and a second straight line formed by connecting the first target icon and the second target icon in an initial state; determine whether an included angle formed between the first straight line and the second straight line exceeds a preset threshold; and, when the included angle exceeds the preset threshold, reset the second target icon.

In some embodiments, the apparatus further includes a second determination module, configured to, when the included angle exceeds the preset threshold, release the second target icon after completing the dragging operation so that the second target icon moves along the designated direction; acquire an incidence angle between the second target icon and a boundary when the second target icon collides with the boundary on the operation interface; and, according to the incidence angle, control the second target icon to perform at least one boundary rebound action before moving to the position of the first target icon for merging.

In some embodiments, the icon merging module 34 is configured to calculate a distance value between the first position coordinate and the second position coordinate, and, based on the movement path, move the second target icon to a position at the distance value from itself to merge with the first target icon.

In some embodiments, the apparatus further includes a detection module, configured to detect whether a dragging speed falls within a preset value range, and when the dragging speed does not fall within the preset value range, replace the dragging speed with a maximum preset speed or a minimum preset speed closest to the dragging speed.

In some embodiments, the apparatus further includes a third response module, configured to, in response to a second long-press operation on any icon on the operation interface, pop up a confirmation control for indicating whether to convert the current icon from an initial state into a receiving state; and, when it is detected that the confirmation control is triggered, take the current icon as the first target icon. The second long-press operation specifically refers to continuously pressing an icon for a duration greater than a third preset value. In the present disclosure, any two of the first preset value, the second preset value, and the third preset value may be the same or different.

In some embodiments, the apparatus further includes a fourth response module, configured to place the first target icon at the topmost layer of the operation interface; and, in response to a page-switching operation on the operation interface, switch the current page to another page while keeping the first target icon stationary.

In specific implementations, the above modules may be implemented as independent entities, or may be combined in any manner and implemented as the same entity or as several entities.

As described above, in the desktop icon arrangement apparatus 30 provided by the embodiments of the present disclosure, the first response module 31 is configured to respond to a first touch operation on a first target icon on an operation interface and record a first position coordinate of the first target icon on the operation interface; the second response module 32 is configured to respond to a second touch operation on any second target icon on the operation interface other than the first target icon and record a second position coordinate of the second target icon when the second touch operation on the operation interface is completed; the path creation module 33 is configured to create a movement path between the first target icon and the second target icon according to the first position coordinate and the second position coordinate; and the icon merging module 34 is configured to, based on the movement path, move the second target icon to the position of the first target icon for merging.

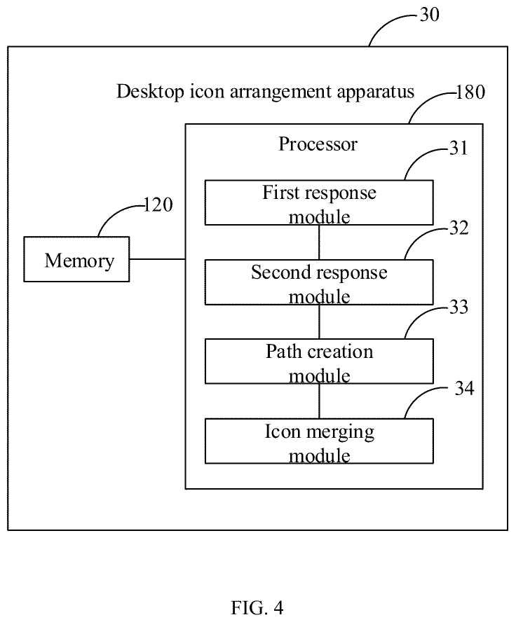

Refer to FIG. 4 illustrating a block diagram of the desktop icon arrangement apparatus according to another embodiment of the present disclosure. The desktop icon arrangement apparatus 30 includes a memory 120, one or more processors 180, and one or more applications. The one or more applications are stored in the memory 120 and configured to be executed by the processor 180. The processor 180 may include a first response module 31, a second response module 32, a path creation module 33, and an icon merging module 34.

For example, the structure and connection relationships of the above components may be as follows:

The memory 120 may be used to store applications and data. The applications stored in the memory 120 contain executable code. The applications may constitute various functional modules. The processor 180 performs various functional applications and data processing by running the applications stored in the memory 120. In addition, the memory 120 may include high-speed random access memory and may also include non-volatile memory, such as at least one disk memory device, flash memory device, or other volatile or non-volatile solid-state memory device. Correspondingly, the memory 120 may further include a memory controller for providing the processor 180 with access to the memory 120.

The processor 180 serves as the control center of the apparatus. It connects various parts of the terminal through multiple interfaces and buses, and by executing applications stored in the memory 120 and invoking data stored in the memory 120, performs various device functions and data processing to provide overall control of the apparatus. Optionally, the processor 180 may include one or more processing cores; preferably, the processor 180 may integrate an application processor and a modem processor, where the application processor mainly handles the operating system, user interface, and applications.

Specifically, in the present embodiment, the processor 180 executes the following instructions by loading executable code corresponding to one or more application processes into the memory 120 and running the applications stored in the memory 120 to implement various functions:

First response instruction is configured to respond to a first touch operation on a first target icon on an operation interface and record a first position coordinate of the first target icon on the operation interface.

Second response instruction is configured to respond to a second touch operation on any second target icon on the operation interface other than the first target icon and record a second position coordinate of the second target icon when the second touch operation on the operation interface is completed.

Path creation instruction is configured to create a movement path between the first target icon and the second target icon according to the first position coordinate and the second position coordinate.

Icon merging instruction is configured to, based on the movement path, move the second target icon to the position of the first target icon for merging.

In some embodiments, the second touch operation specifically refers to a clicking operation on the second target icon.

In some embodiments, the second touch operation specifically includes performing a first long-press operation on the second target icon so that the second target icon is granted dragging permission, and dragging the second target icon having the dragging permission in a designated direction.

In some embodiments, the instructions further include a first determination instruction, configured to determine a first straight line formed according to the designated direction and a second straight line formed by connecting the first target icon and the second target icon in an initial state; determine whether an included angle formed between the first straight line and the second straight line exceeds a preset threshold; and, when the included angle exceeds the preset threshold, reset the second target icon.

In some embodiments, the instructions further include a second determination instruction, configured to, when the included angle exceeds the preset threshold, release the second target icon after completing the dragging operation so that the second target icon moves along the designated direction; acquire an incidence angle between the second target icon and a boundary when the second target icon collides with the boundary on the operation interface; and, according to the incidence angle, control the second target icon to perform at least one boundary rebound action before moving to the position of the first target icon for merging.

In some embodiments, the icon merging instruction is configured to calculate a distance value between the first position coordinate and the second position coordinate, and, based on the movement path, move the second target icon to a position at the distance value from itself to merge with the first target icon.

In some embodiments, the icon merging instruction is configured to calculate a distance value between the first position coordinate and the second position coordinate, and, based on the movement path, move the second target icon to a position at the distance value from itself to merge with the first target icon.

In some embodiments, the instructions further include a detection instruction, configured to detect whether a dragging speed falls within a preset value range, and when the dragging speed does not fall within the preset value range, replace the dragging speed with a maximum preset speed or a minimum preset speed closest to the dragging speed.

In some embodiments, the instructions further include a third response instruction, configured to, in response to a second long-press operation on any icon on the operation interface, pop up a confirmation control for indicating whether to convert the current icon from an initial state into a receiving state; and, when it is detected that the confirmation control is triggered, set the current icon as the first target icon.

In some embodiments, the instructions further include a fourth response instruction, configured to place the first target icon at the topmost layer of the operation interface; and, in response to a page-switching operation on the operation interface, switch the current page to another page while keeping the first target icon stationary.

The embodiments of the present disclosure further provide a terminal device. The terminal device may be a server, a smartphone, a computer, a tablet computer, or another device.

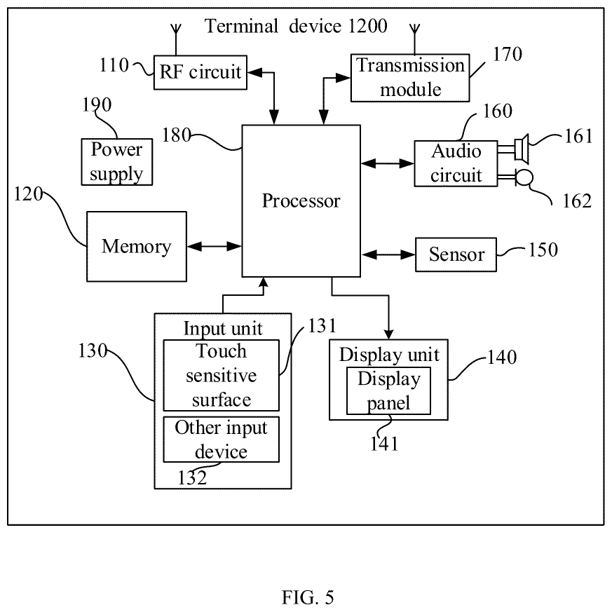

Refer to FIG. 5 depicting a block diagram of the terminal device according to another embodiment of the present disclosure. The terminal device can be used to implement the desktop icon arrangement method described in the above embodiments. The terminal device 1200 may be, for example, a television, a smartphone, or a tablet computer.

As shown in Fig., the terminal device 1200 may include an RF (Radio Frequency) circuit 110, a memory 120 including one or more computer-readable storage media (only one is shown in the figure), an input unit 130, a display unit 140, a sensor 150, an audio circuit 160, a transmission module 170, a processor 180 including one or more processing cores (only one is shown in the figure), and a power supply 190.

It should be understood by those skilled in the art that the structure of the terminal device 1200 shown in FIG. 5 does not limit the terminal device 1200 and may include more or fewer components than those illustrated, or combine certain components, or arrange components in different configurations.

The RF circuit 110 is configured to receive and transmit electromagnetic waves and to realize the mutual conversion between electromagnetic waves and electrical signals, thereby enabling communication with a communication network or other devices. The RF circuit 110 may include various existing circuit components used to perform these functions, such as an antenna, a radio frequency transceiver, a digital signal processor, an encryption/decryption chip, a user identity module (SIM) card, and memory, among others. The RF circuit 110 may communicate with various networks, such as the Internet, an intranet, or a wireless network, or communicate with other devices through a wireless network.

The memory 120 may be used to store software programs and modules, such as the program instructions/modules corresponding to the desktop icon arrangement method described in the above embodiments. The processor 180 executes various functional applications and performs data processing by running software programs and modules stored in the memory 120. The processor 180 can automatically select a vibration reminder mode for performing desktop icon arrangement according to the current scenario of the terminal device, thereby ensuring that scenes such as meetings are not disturbed while ensuring that a user can perceive incoming calls, thus improving the intelligence of the terminal device. The memory 120 may include high-speed random access memory and may also include non-volatile memory, such as one or more magnetic storage devices, flash memories, or other non-volatile solid-state storage devices. In some examples, the memory 120 may further include memory remotely arranged relative to the processor 180, which may be connected to the terminal device 1200 through a network. Examples of the network include, but are not limited to, the Internet, an intranet, a local area network, a mobile communication network, or a combination thereof.

The input unit 130 may be configured to receive input numerical or character information and generate signals related to user settings and function control, such as signals from a keyboard, a mouse, a joystick, an optical device, or a trackball. Specifically, the input unit 130 may include a touch-sensitive surface 131 and other input devices 132. The touch-sensitive surface 131, also referred to as a touch display screen or touchpad, may collect touch operations performed by a user on or near the surface (for example, using a finger, stylus, or any other suitable object or accessory) and drive a corresponding connected device according to a preset program. Optionally, the touch-sensitive surface 131 may include two components: a touch detection device and a touch controller. The touch detection device detects a user's touch position and the signals generated by the touch operation and transmits the signals to the touch controller. The touch controller receives the touch information from the touch detection device, converts it into touch coordinates, and sends it to the processor 180, and may also receive and execute commands issued by the processor 180. Furthermore, the touch-sensitive surface 131 may be implemented in various forms, such as resistive, capacitive, infrared, or surface acoustic wave types.

In addition to the touch-sensitive surface 131, the input unit 130 may also include other input devices 132. Specifically, the other input devices 132 may include, but are not limited to, one or more of a physical keyboard, function keys (such as volume control keys, power keys, etc.), a trackball, a mouse, and a joystick.

The display unit 140 may be used to display information input by a user or information provided to a user, as well as various graphical user interfaces of the terminal device 1200. These graphical user interfaces may be composed of graphics, text, icons, videos, or any combination thereof. The display unit 140 may include a display panel 141, which may optionally be configured in the form of an LCD (Liquid Crystal Display) or an OLED (Organic Light-Emitting Diode) panel. Furthermore, the touch-sensitive surface 131 may cover the display panel 141. When the touch-sensitive surface 131 detects a touch operation on or near its surface, it transmits the detected signal to the processor 180 to determine the type of touch event. The processor 180 then provides a corresponding visual output on the display panel 141 according to the type of touch event. Although the touch-sensitive surface 131 and the display panel 141 are implemented as two separate components to perform input and output functions in FIG. 5, in certain embodiments, the touch-sensitive surface 131 and the display panel 141 may be integrated to perform both input and output functions.

The terminal device 1200 may further include at least one sensor 150, such as a light sensor, a motion sensor, or other sensors. Specifically, the light sensor may include an ambient light sensor and a proximity sensor. The ambient light sensor may adjust the brightness of the display panel 141 according to the brightness of ambient light, while the proximity sensor may turn off the display panel 141 and/or its backlight when the terminal device 1200 is moved close to the user's ear. As an example of a motion sensor, an accelerometer may detect the magnitude of acceleration in various directions (typically three axes). When stationary, it may detect the magnitude and direction of gravity, which can be used in applications for recognizing the orientation of the mobile device (such as screen rotation, motion-based games, or magnetometer calibration), and in vibration-detection functions (such as pedometers or tap recognition). Other sensors that may be configured in the terminal device 1200, such as a gyroscope, barometer, hygrometer, thermometer, or infrared sensor, are not described in detail herein.

The audio circuit 160, speaker 161, and microphone 162 provide an audio interface between the user and the terminal device 1200. The audio circuit 160 may convert received audio data into an electrical signal and transmit it to the speaker 161, which then converts the electrical signal into an audible sound output. Conversely, the microphone 162 converts collected sound signals into electrical signals, which are received by the audio circuit 160 and converted into audio data. The audio data may then be processed by the processor 180 and transmitted to another terminal through the RF circuit 110, or stored in the memory 120 for further processing. The audio circuit 160 may also include an earphone jack to enable communication between peripheral earphones and the terminal device 1200.

The terminal device 1200 may transmit and receive emails, browse web pages, and access streaming media through the transmission module 170 (for example, a Wi-Fi module), thereby providing a user with wireless broadband Internet access. Although FIG. 5 illustrates the transmission module 170, it should be understood that the transmission module is not an essential component of the terminal device 1200 and may be omitted as needed without departing from the essence and scope of the present invention.

The processor 180 serves as the control center of the terminal device 1200. It connects various parts of the mobile device through multiple interfaces and circuit connections and performs overall control by running or executing software programs and/or modules stored in the memory 120 and by invoking data stored in the memory 120. The processor 180 executes various functions of the terminal device 1200 and processes data accordingly. Optionally, the processor 180 may include one or more processing cores. In some embodiments, the processor 180 may integrate an application processor and a modem processor, wherein the application processor primarily handles the operating system, user interface, and applications, while the modem processor primarily handles wireless communications. It should be understood that the modem processor may also be implemented separately from the processor 180.

The terminal device 1200 further includes a power supply 190 for supplying power to each component. In some embodiments, the power supply 190 may be logically connected to the processor 180 through a power management system, thereby enabling the management of discharging and power consumption through the power management system. The power supply 190 may also include one or more direct-current (DC) or alternating-current (AC) power sources, a rechargeable system, a power fault detection circuit, a power converter or inverter, and a power status indicator, among other components.

Although not shown, the terminal device 1200 may further include a camera (such as a front camera and/or a rear camera), a Bluetooth module, and other components, which are not described in detail herein.

In this embodiment, the display unit 140 of the terminal device 1200 is a touch screen display. The terminal device 1200 further includes a memory 120 and one or more programs. The one or more programs are stored in the memory 120 and are configured to be executed by one or more processors 180. The one or more programs include instructions for performing the following operations:

A first response instruction configured to respond to a first touch operation on a first target icon on an operation interface and record a first position coordinate of the first target icon on the operation interface;

A second response instruction configured to respond to a second touch operation on any second target icon on the operation interface other than the first target icon and record a second position coordinate of the second target icon when the second touch operation on the operation interface is completed;

A path creation instruction configured to create a movement path between the first target icon and the second target icon according to the first position coordinate and the second position coordinate; and

An icon merging instruction configured to move the second target icon to a position of the first target icon for merging based on the movement path.

In some embodiments, the second touch operation specifically refers to a clicking operation on the second target icon.

In some embodiments, the second touch operation specifically includes performing a first long-press operation on the second target icon so that the second target icon is granted a dragging permission, and dragging the second target icon with the granted dragging permission in a designated direction.

In some embodiments, the program further includes a first determination instruction configured to determine a first straight line formed in the designated direction and a second straight line formed by connecting the first target icon and the second target icon in an initial state; determine whether an included angle formed between the first straight line and the second straight line exceeds a preset threshold; and, when the included angle exceeds the preset threshold, reset the second target icon.

In some embodiments, the program further includes a second determination instruction configured to, when the included angle exceeds the preset threshold, release the second target icon after completing the dragging operation so that the second target icon moves in the designated direction; obtain an incidence angle between the second target icon and a boundary when the second target icon collides with the boundary on the operation interface; and control the second target icon to perform at least one boundary rebound action based on the incidence angle before moving to the position of the first target icon for merging.

In some embodiments, the icon merging instruction is configured to calculate a distance value between the first position coordinate and the second position coordinate, and based on the movement path, move the second target icon to a position at the distance value to merge with the first target icon.

In some embodiments, the icon merging instruction is configured to calculate a distance value between the first position coordinate and the second position coordinate, and based on the movement path, move the second target icon to a position at the distance value to merge with the first target icon.

In some embodiments, the program further includes a detection instruction configured to detect whether a dragging speed falls within a preset value range. When the dragging speed does not fall within the preset value range, the dragging speed is replaced with the maximum or minimum preset speed that is closest to the detected dragging speed.

In some embodiments, the program further includes a third response instruction configured to respond to a second long-press operation on any icon on the operation interface by displaying a confirmation control used to indicate whether the current icon is to be converted from an initial state into a receiving state. When it is detected that the confirmation control has been triggered, the current icon is set as the first target icon.

In some embodiments, the program further includes a fourth response instruction configured to place the first target icon at the topmost layer of the operation interface and, in response to a page-switching operation on the operation interface, switch the current page to another page while keeping the first target icon stationary.

The present disclosure further provides a terminal device, which may be a smartphone, a computer, or other similar devices.

As described above, the embodiment of the present disclosure provides a terminal device 1200 configured to perform the following operations:
in response to a first touch operation on a first target icon on an operation interface, record a first position coordinate of the first target icon on the operation interface;
in response to a second touch operation on any second target icon on the operation interface other than the first target icon, record a second position coordinate of the second target icon when the second touch operation on the operation interface is completed;
create a movement path between the first target icon and the second target icon according to the first position coordinate and the second position coordinate; and based on the movement path, move the second target icon to the position of the first target icon for merging.

The present disclosure further provides a storage medium. The storage medium stores a computer program which, when executed on a computer, causes the computer to perform the desktop icon arrangement method described in any of the embodiments above.

It should be noted that, for the desktop icon arrangement method described in the present disclosure, those skilled in the art can understand that all or part of the processes of implementing the method of the embodiments of the present disclosure may be performed by controlling relevant hardware through a computer program. The computer program can be stored in a computer-readable storage medium, such as a memory of a terminal device, and executed by at least one processor within the terminal device. During execution, the process may include the steps described in the embodiments of the desktop icon arrangement method. The storage medium may be, for example, a magnetic disk, an optical disk, a read-only memory (ROM), or a random access memory (RAM).

For the desktop icon arrangement device described in the embodiments of the present disclosure, its various functional modules may be integrated into one processing chip, may exist physically as separate modules, or two or more modules may be integrated into one module. The integrated modules may be implemented in hardware form or as software functional modules. When the integrated modules are implemented as software functional modules and sold or used as an independent product, they may also be stored in a computer-readable storage medium, such as a read-only memory, a magnetic disk, or an optical disk.

The desktop icon arrangement method, device, medium, and equipment provided in the embodiments of the present disclosure have been described in detail above. Specific examples have been used to illustrate the principles and implementation of the present disclosure. The descriptions of the above embodiments are provided merely to assist in understanding the method and core concepts of the present disclosure. It should be understood by those skilled in the art that modifications may be made to the specific implementation methods and application scopes based on the ideas of the present disclosure. Therefore, the contents of this specification should not be construed as limiting the scope of the present disclosure.

What is claimed is:

1. A desktop icon arrangement method, comprising:
responding to a first touch operation on a first target icon on an operation interface;
responding to a second touch operation on a second target icon on the operation interface;
obtaining a first position coordinate and a second position coordinate corresponding to the first target icon and the second target icon, respectively;
creating a movement path between the first target icon and the second target icon according to the first position coordinate and the second position coordinate; and
based on the movement path, moving the second target icon to a position of the first target icon for merging.

2. The desktop icon arrangement method according to claim 1, wherein the first touch operation is triggered by a duration of continuously pressing the first target icon exceeding a first preset value.

3. The desktop icon arrangement method according to claim 1, wherein the first touch operation is triggered by continuously clicking the first target icon N times, where Nis an integer greater than 1.

4. The desktop icon arrangement method according to claim 1, wherein the first touch operation is triggered by performing a circling operation or a check-mark operation on the first target icon.

5. The desktop icon arrangement method according to claim 1, wherein the second touch operation refers to a clicking operation on the second target icon.

6. The desktop icon arrangement method according to claim 5, wherein a number of the clicking operations is at least two.

7. The desktop icon arrangement method according to claim 1, wherein the second touch operation comprises:
performing a first long-press operation on the second target icon to grant the second target icon a dragging permission; and
dragging the second target icon having the dragging permission in a designated direction.

8. The desktop icon arrangement method according to claim 7, further comprising:
determining a first straight line formed by the designated direction, and a second straight line formed by connecting the first target icon and the second target icon in an initial state;
determining whether an included angle formed between the first straight line and the second straight line exceeds a preset threshold; and
when the included angle exceeds the preset threshold, resetting the second target icon.

9. The desktop icon arrangement method according to claim 8, further comprising:
when the included angle exceeds the preset threshold, releasing the second target icon after completing the dragging operation so that the second target icon moves along the designated direction;
acquiring an incidence angle between the second target icon and a boundary when the second target icon collides with the boundary on the operation interface; and
controlling the second target icon to perform at least one boundary rebound action according to the incidence angle, and then moving to a position of the first target icon for merging.

10. The desktop icon arrangement method according to claim 7, wherein based on the movement path, moving the second target icon to the position of the first target icon for merging comprises:
calculating a distance value between the first position coordinate and the second position coordinate; and
based on the movement path, moving the second target icon to a position at the distance value from itself to merge with the first target icon.

11. The desktop icon arrangement method according to claim 10, wherein based on the movement path, moving the second target icon to the position of the first target icon for merging comprises:
calculating a dragging speed of the second target icon during a dragging operation; and
based on the movement path, moving the second target icon at the dragging speed to a position at the distance value from itself to merge with the first target icon.

12. The desktop icon arrangement method according to claim 10, further comprising:
detecting whether the dragging speed falls within a preset value range, and when the dragging speed does not fall within the preset value range, replacing the dragging speed with a maximum preset speed or a minimum preset speed that is closest to the dragging speed.

13. The desktop icon arrangement method according to claim 1, wherein before responding to the first touch operation on the first target icon on the operation interface, the method further comprises:
responding to a second long-press operation on any icon on the operation interface, and popping up a confirmation control used to indicate whether to convert a current icon from an initial state into a receiving state; and
when detecting that the confirmation control is triggered, setting the current icon as the first target icon.

14. The desktop icon arrangement method according to claim 1, wherein after responding to the first touch operation on the first target icon on the operation interface, the method further comprises:
placing the first target icon at a topmost layer of the operation interface; and
responding to a page switching operation on the operation interface to switch a current page to another page while the first target icon remains unmoved.

15-19. (canceled)

20. A terminal device, comprising a memory, a processor, and instructions stored in the memory and executable by the processor to implement operations comprising:
responding to a first touch operation on a first target icon on an operation interface;
responding to a second touch operation on a second target icon on the operation interface;
obtaining a first position coordinate and a second position coordinate corresponding to the first target icon and the second target icon respectively;
creating a movement path between the first target icon and the second target icon according to the first position coordinate and the second position coordinate; and
based on the movement path, moving the second target icon to a position of the first target icon for merging.

21. The terminal device according to claim 20, wherein the first touch operation is triggered by a duration of continuously pressing the first target icon exceeding a first preset value.

22. The terminal device according to claim 20, wherein the first touch operation is triggered by continuously clicking the first target icon N times, where N is an integer greater than 1.

23. The terminal device according to claim 20, wherein the first touch operation is triggered by performing a circling operation or a check-mark operation on the first target icon.

24. The terminal device according to claim 20, wherein the second touch operation refers to a clicking operation on the second target icon.

25. The terminal device according to claim 20, wherein the second touch operation comprises:
performing a first long-press operation on the second target icon to grant the second target icon a dragging permission; and
dragging the second target icon having the dragging permission in a designated direction.
